(19) United States
(12) Patent Application Publication
(10) Pub. No.: US 2014/0052656 A1
(43) Pub. Date: Feb. 20, 2014

(54) SYSTEMS AND METHODS FOR COMBINATION SOCIAL AND BUSINESS NETWORK

(71) Applicant: Jobagrob, Inc., La Mesa, CA (US)

(72) Inventor: Austin A. Ball, La Mesa, CA (US)

(73) Assignee: Jobagrob, Inc., La Mesa, CA (US)

(21) Appl. No.: 13/960,097

(22) Filed: Aug. 6, 2013

Related U.S. Application Data
(60) Provisional application No. 61/684,045, filed on Aug. 16, 2012.

(51) Int. Cl. G06Q 10/10; G06Q 50/00

(52) U.S. Cl. CPC G06Q 10/1053; G06Q 50/01
USPC 705/319

(57) ABSTRACT

In a system and method for providing social business-networking, a social interface is provided between the first user and each of the plurality of second users. The social interface comprises a social user interface for social content sharing between the first user and the plurality of second users. A professional relationship may also be established between the first user and an employer. A résumé may be automatically generated for the first user. A professional interface is provided between the first user and the employer.

### RELATED APPLICATION

The present invention claims the benefit of co-pending U.S. provisional patent application No. 61/684,045 filed on Aug. 16, 2012, the contents of which are incorporated herein by reference in their entirety.

### BACKGROUND

1. Field of the Invention

The invention is generally directed to social and business networks, and, more particularly, to a platform for utilizing a combination social and business network to establish both social and professional relationships and interfaces between users.

2. Description of the Related Art

There are various social networks available today, in varying formats (e.g., Facebook®, Twitter®, Google+®, MySpace®, Instagram®). In addition, there are a number of employment-related networks. For instance, LinkedIn® connects people with business opportunities. Monster® builds traditional résumés for individuals and aids employers during the hiring process. However, currently, there is no networking site that combines the functions and capabilities of both social and business-networking sites. As a result, there is not an employment-related network that appeals to and inspires the social-networking-oriented younger generation. For instance, LinkedIn's user base is primarily adults who have already established themselves as college graduates and/or already have significant work experience. Moreover, most users of professional sites, such as LinkedIn® and Monster®, utilize the sites in a similar manner as their email. Users will typically check their account once or twice a week, for example, to check job postings. There is little, if anything, to engender a greater degree of involvement, interaction, or engagement.

Furthermore, the résumé-building functions of such sites follow traditional, familiar guidelines with conventional, sterile results: a text-based and categorized description of the job applicant's education, work experience, and professional affiliations. Occasionally, such résumés attempt to portray an individual's passions and inspirations through information such as personal interests or hobbies. However, these résumés do a poor job at revealing an applicant's actual character and attributes, and can often under-represent or misrepresent the applicant's true nature.

Similarly, the traditional interview also fails in this regard. In part due to today's competitive employment market, generally, by the interview stage, all interviewees have already been identified as meeting the employer's hiring requirements (e.g., education, GPA, work experience, etc.). Thus, at this stage, the employer is typically evaluating applicants based on how passionate they are about the work, how well they would fit into the corporate culture, etc. However, both parties to an interview typically only have a total of 15-30 minutes to interact. It is nearly impossible, within this time frame, for the interviewee to provide enough information about his or her life to properly convey the interviewee's true character and attributes.

Accordingly, it would be advantageous to applicants and employers alike to be able to efficiently convey, not only the education and experience of an applicant, as captured in a traditional résumé, but also more subjective attributes regarding the applicant, such as what motivates and inspires the applicant, how well the applicant would fit into a particular work environment, the applicant's social support structures, and the like.

The combination of an employment-related site with social networking functions (e.g., message and media posting, specialized news feeds tailored to a user's interests and social relationships, etc.) could inspire users—and especially younger students, such as college students—to interact socially with the site on a daily basis, resulting in greater diversity and involvement, and a richer collection of personal history. Simultaneously, the system could help job seekers market themselves to potential employers, while helping employers identify applicants who have desired characteristics and attributes. Such a site could be especially beneficial for tapping into the often neglected and undervalued pool of employment-seeking college students.

### SUMMARY

Accordingly, to correct these deficiencies in current employment-related networking sites, systems and methods for a combination social-business networking site are disclosed. In an embodiment, the systems and methods provide resources for building a representation of and displaying an individual's life in a professional setting, by collecting interactions and relationships formed through a social network medium. Users of these systems and methods may include students, employers, colleges/universities, and others. For instance, by interacting with the social networking aspects of the system, a student or other job-seeking user can generate data which the system can automatically use to build an unconventional, yet professional, résumé or media-centric portfolio.

The system may collect descriptive data from a variety of individuals, and utilize this descriptive data to provide search capabilities. For instance, an employer can specify search criteria which are matched against the descriptive data to narrow a pool of potential job applicants to a manageable number. In an embodiment, the search criteria may be based on a similarity score which can be computed between employers and users.

The system may interpret the acquired descriptive data to connect users with non-employer users, in addition to employer users. The system's social network may be tailored to the needs of the user and aid the user in making appropriate relationships and connections with other users. The social network may have the ability to provide direct communications between users through live streaming video, audio, and messaging interfaces. In addition, the system may constantly update all input, user activities, and news feeds between users.

In an embodiment, a mobile application may also be provided, which allows users to access the system in real time and participate in live conference video/audio communications with other users, including employers.

In an embodiment, a system for providing social business-networking is disclosed. The system comprises: at least one hardware processor; and at least one executable software module that, when executed by the at least one hardware processor, establishes social relationships between a first user and a plurality of second users, provides a social interface between the first user and each of the plurality of second users, wherein the social interface comprises a social user interface for social content sharing between the first user and the plurality of second users, establishes a professional relationship between the first user and a third user, wherein the third user is associated with an employer, automatically generates a résumé for the first user, and provides a professional interface between the first user and the third user, wherein the professional interface provides a professional user interface to the third user, wherein the professional user interface comprises the résumé.

In another embodiment, a method for providing social business-networking is disclosed. The method comprises, by at least one hardware processor: establishing social relationships between a first user and a plurality of second users; providing a social interface between the first user and each of the plurality of second users, wherein the social interface comprises a social user interface for social content sharing between the first user and the plurality of second users; establishing a professional relationship between the first user and a third user, wherein the third user is associated with an employer; automatically generating a résumé for the first user; and providing a professional interface between the first user and the third user, wherein the professional interface provides a professional user interface to the third user, wherein the professional user interface comprises the résumé.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example system, according to an embodiment;

FIG. 2 illustrates example modules of a system, according to an embodiment;

FIG. 3 illustrates an example portfolio builder module, according to an embodiment;

FIG. 4 illustrates an example process of providing a dual social and business networking site, according to an embodiment;

FIG. 5 illustrates an example process for establishing a connection between two users, according to an embodiment;

FIGS. 6A-6C illustrate an example interactive video presentation, according to an embodiment;

FIGS. 7A-7D illustrate example user interfaces that may be presented to non-employer users, according to an embodiment;

FIGS. 8A-8D illustrate example user interfaces that may be presented to employer users, according to an embodiment;

FIG. 9 illustrates some example database structures that may be utilized in the system of FIGS. 1 to 8D; and

FIG. 10 illustrates a processing system on which one or more of the processes described herein may be executed, according to an embodiment.

### DETAILED DESCRIPTION

In an embodiment, a system and method for implementing and managing a social network while matching employment-seeking individuals to potential employers is disclosed. Essentially, such a system may act as a social recruitment tool to help individuals obtain an interview or job quickly and/or regardless of a user's experience in a given field. The system may, at least initially, be designed for and targeted at college students interested in “getting a foot in the door” in the context of business connections. Thus, initially, the primary target population may be college students who are interested in building a professional profile and professional image for future employers, while also developing social relationships with other students. The disclosed systems and methods may benefit individuals who are social and love to share media content, whether or not they do well in interview-type scenarios, and/or those who need help “getting their foot in the door.” The disclosed systems and methods may also help employers who are seeking employees who better fit their companies' cultures, rather than typical head-in-the-books employees who disregard the need to gain knowledge in social dynamics. However, it should be understood that the systems and methods disclosed herein are not limited by any particular target demographic.

In an embodiment, a social networking site, incorporating a job market, is provided. The site may, initially, only be available to students from one or more colleges and/or universities (e.g., Cal Poly), and then subsequently expanded to other colleges and/or universities, although it should be understood that the disclosed systems and methods are not so limited.

There may be two views or sides to the site: one for non-employer users (e.g., college students), and another for employer users (e.g., proprietorships, partnerships, companies, or other entities seeking potential employees). The non-employer user may be provided with beneficial functions, such as creating a profile, uploading media (e.g., videos, images, etc.), applying for jobs, and accepting interviews and/or jobs. The employer user may also be provided with beneficial functions, such as creating a company profile, uploading media (e.g., videos, images, etc.), posting job opportunities, accepting candidates for employment, and conducting interviews. Both the non-employer and employer users may also be provided with additional functions, such as private messaging, commenting on media, and following other non-employer and/or employer users.

Although users may be provided the ability to upload conventional (e.g., one-page) or generic résumés, instead of relying on such résumés, the site may focus on the personality of an individual, such as a job seeker. Thus, rather than, or in addition to, traditional text-based résumés, the site may use videos, images (e.g., photographs), animations, and/or other types of media to showcase a candidate's personality and skills.

In an embodiment, when a non-employer user logs in, he or she may be presented with a news feed, as well as group pages with job opportunities for which the user can apply. The user may also be provided with a profile page, through which the user may provide videos of himself or herself. These videos can showcase the user's character and personality to potential employers. In addition, functionality may be provided which allows other users (e.g., college students) to comment on and “like” other users' (e.g., college students') videos. Thus, users can see how other users are presenting themselves or “putting themselves out there,” who is being creative, what types of videos or presentations are resulting in other users getting hired, etc. In an embodiment, one or more of these things can be displayed in a user's news feed (e.g., a user can be informed if another user posts a video or other content, gets an interview, gets hired, etc.).

For employer users, the site may comprise one or more user interfaces for posting job opportunities, searching for or otherwise identifying potential employees, and updating their statuses for users who are following the employer users.

System Overview

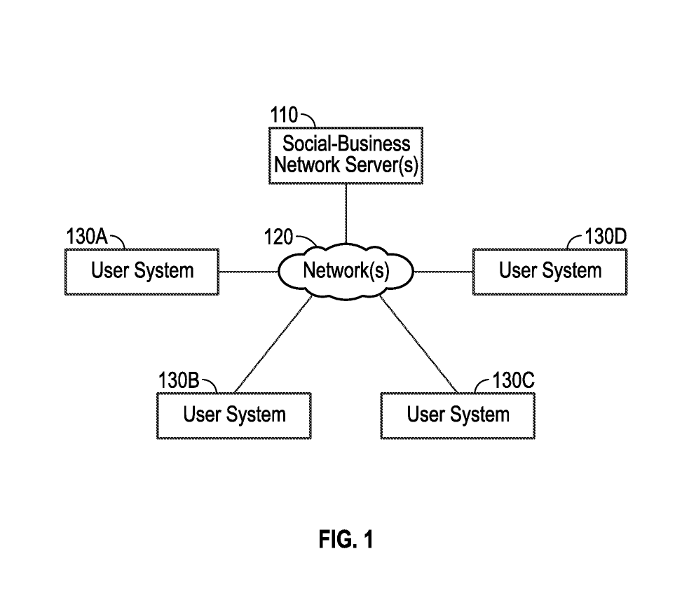

FIG. 1 illustrates an example combination social and business networking system, according to an embodiment. The system comprises a set of one or more social-business network servers 110 which host and/or execute one or more of the various software modules described herein. In addition, the server(s) 110 are communicatively connected to one or more user systems 130 via one or more network(s) 120. The network(s) 120 may comprise the Internet, and server(s) 110 may communicate with user system(s) 130 through the Internet using standard transmission protocols, such as HyperText Transfer Protocol (HTTP), Secure HTTP (HTTPS), File Transfer Protocol (FTP), and the like. In an alternative embodiment, server(s) 110 may not be dedicated servers, and may instead be cloud instances, which utilize shared resources of one or more servers. User system(s) 130 may comprise any type or types of computing devices capable of wired and/or wireless communication, including without limitation, desktop computers, laptop computers, tablet computers, smart phones or other mobile phones, and/or servers.

Server(s) 110 may comprise web servers which host a website or web services. In embodiments in which a website is provided, the website may comprise one or more user interfaces, including, for example, webpages generated in HyperText Markup Language (HTML) or other language. The server(s) 100 transmit or serve these user interfaces in response to requests from user system(s) 130. The requests and the responses, including the user interfaces, may both be communicated through network(s) 120, which may include the Internet, using standard communication protocols (e.g., HTTP, HTTPS). These user interfaces or webpages may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like. The server may also respond to other requests from user system(s) 130. For example, a user system may submit data (e.g., user data, form data, etc.) to be stored in one or more databases locally and/or remotely accessible to server(s) 110. Such data may be sent to server(s) 110, for instance, using the well-known POST request supported by HTTP. This data, as well as other requests, may be handled, for example, by a servlet executed by server(s) 110.

In embodiments in which a web service is provided, server(s) 110 may receive requests from user system(s) 130, and provide responses in eXtensible Markup Language (XML) and/or another suitable format. In such embodiments, server(s) 110 may provide an application programming interface (API) which defines the manner in which user system(s) 130 may interact with the web service. Thus, the user system(s) 130, which may themselves be servers, can define their own user interfaces, and rely on the web service to implement the backend processes, functionality, storage, etc., described herein.

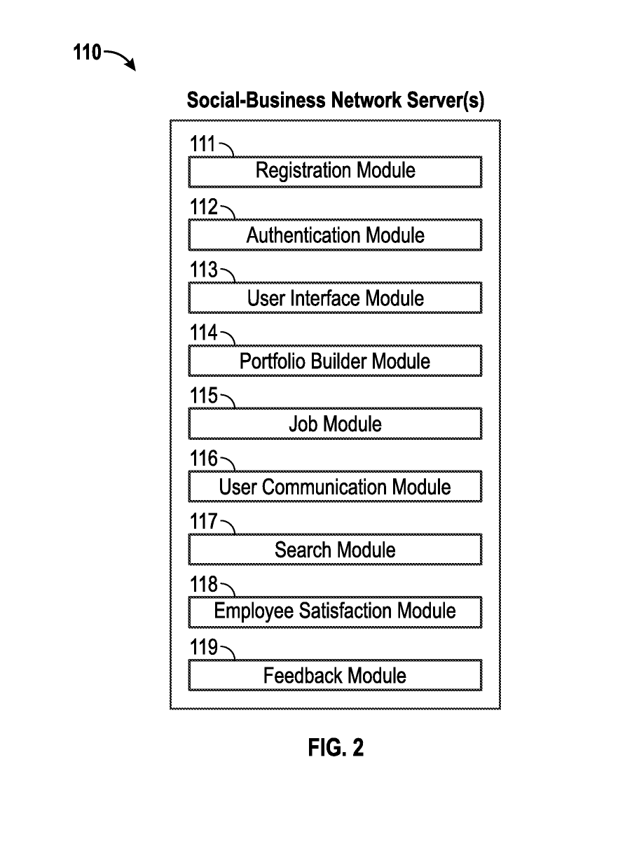

FIG. 2 illustrates various modules that may be integrated with, hosted, and/or executed by social-business network server(s) 110. For example server(s) 110 may comprise a registration module 111, authentication module 112, user interface module 113, portfolio builder module 114, similarity determination module 115, user communication module 116, search module 117, employee satisfaction module 118, and/or feedback module 119. These modules may be implemented as software, hardware, or a combination of software and hardware. It should be understood that these modules are merely illustrative, and that different implementations of server(s) 110 may comprise fewer, more, and/or different modules than those illustrated herein.

In an embodiment, registration module 111 receives information from (e.g., via inputs of a user interface) and/or generates information for users of the system, including authentication information (e.g., username/email and password, digital certificate, etc.), identifying information (e.g., first name, last name, type of user such as student, employed, employer, university, etc.), and contact information (e.g., email address, phone number, postal address), as well as additional information about the user. In an embodiment, the user may only be required to provide a username/email, password, and first and last name, and the other information may be optional and/or may be input at a later time. Alternatively, more, less, or different combinations of information may be required. This information may be stored as a user profile for each user, which may be stored in one or more databases locally and/or remotely accessible to server(s) 110.

A user may specify privacy settings for his or her profile (e.g., public, private, etc.) or individually for separate aspects of the profile. For social media content sharing, server(s) 110 may provide an internal upload system for private content use. Profile privacy settings can have strict parameters to ensure a user's portfolio (e.g., comprising the user's personal information and/or portfolio of media) is professional and credible. For example, these privacy settings may comprise user-to-employer only, user-to-non-employer only, and public. In an embodiment, each media (e.g., video) can inherit these settings as a default parameter, but may be altered according to a user's personal preference.

Some of the information requested or required by the system may be dependent on the type of user. For instance, for a non-employer or job-seeking user, additional requested information may include, without limitation, a statement describing the user, gender, age, country, state, Zip code, current college or university, degree(s), level of degree(s), high school, whether the user is willing to move or change residences for a job, occupation(s) and date(s), photograph(s), video(s), other media, commentary on media, date that the user registered, last login or activity date, news or other data feed(s), and/or responses to questions or requests. The non-employer user may be provided certain questions to answer, and in some embodiments, may be permitted to select among a plurality of questions to answer. These questions may be similar to what would be expected to be included in a cover letter or an admissions essay, and may be directed at enabling a determination of general or specific attributes of the user. For example, such questions or requests may include, without limitation: “Most enriching college experience?”, “Biggest strength?”, “Biggest weakness?”, “A barrier you have overcome?”, “One thing that sets you apart?”, “Narrate the most interesting day or moment in your life.”, “Who is the one person who has influenced you the most? Elaborate.”, “In your opinion, what is the most important aspect of your life and how have you worked to accomplish and better that aspect throughout your life?”, “In one sentence, what is the strangest thing about you?”. The user may be provided with structured input(s) for responding, a free-form input for responding (e.g., textbox), may be permitted to upload a response, etc. In an embodiment, the user is also able to submit optional (or required) videos or other media that can answer one or more questions that the employer may provide for a given job opening.

In an embodiment, to be registered as an employer user, the employer must be qualified or verified. For example, the employer may be required to satisfy certain quality standards to become a verified business with the application. Employers may be added one-by-one to the system to ensure that no spammers or other detrimental entities can disturb users of the system, thereby ensuring that the system remains a high-quality social recruitment tool.

At least some of the information received and/or generated for a user, who is or is associated with an employer, may be different. For instance, a username/email and password may be received for both types of users. However, additional information requested or generated for the employer user may include, without limitation, company name or other identifier, type of work (e.g., selectable from a plurality of categories), location of work, work-related photograph(s), video(s), or other media, job description and/or mission statement, number of company employees, hours of work per day or week, wage (e.g., per hour), salary (e.g., per year), employee satisfaction bar or other indicator, possibility for promotion (e.g., yes/no), dress code, job and/or training requirements, if training is required, whether training is paid, news or other data feed(s), and/or fun facts and/or activities related to the company.

Non-employer users may be thought of as the foundation of embodiments of the disclosed social-business network. The media content, which will directly affect traffic to the site, may be primarily driven by these users. New users may be given the option to connect accounts with other social media sites to the social-business network server(s) 110, e.g., through one or more application programming interfaces (APIs), to bring existing content from these sites into their profile. This may be in addition, or as an alternative, to uploading media via an internal upload function.

Once content is uploaded or imported, non-employer users can start applying for jobs. In an embodiment, a user may be limited to only applying for jobs for which they meet certain specified requirements. Examples of such requirements may include, without limitation, the presence of an introduction video, the presence of a video describing the applicant's previous job, completion of an additional job application form, and/or a headshot of the applicant (e.g., in professional attire). Once a non-employer user has applied for a job, employer users can take the next steps. In this manner, the system can guide the non-employer user, or even force the non-employer user, to construct a professional-looking portfolio.

Employers may be thought of as the giants of the site. They control the recruitment arena. New employers may first be prompted to fill out a profile page which enables users to get a feeling for the employer's environment and culture. The employer may then be prompted to post a job opportunity. In an embodiment, the job opportunity may be posted to a local community page for a community associated with the employer.

In an embodiment, social-business network server(s) 110 may also comprise an authentication module 112 for authenticating registered users with the system. For example, the user may be required to provide a user identifier (e.g., username, email address, etc.) and a password in order to access certain resources of the system. Alternatively or additionally, the user may be required to provide a digital certificate. One of skill in the art will understand that additional or alternative methods of authentication may be utilized. Once a user authenticates with server(s) 110, a user profile and/or other user data, which may be stored in one or more databases locally and/or remotely accessible to server(s) 110, may be retrieved based on a user identifier associated with the user. In an embodiment, when a user logs in to the system (i.e., authenticates), the user can be presented with new updates, such as job offers for jobs to which the user applied, new followers, new job postings/updates from companies that the user is following, new videos in which the user has been referenced or tagged (e.g., a user's video tagged by a follower, a video from another user that the user is following, etc.), new messages, new “likes” or “comments” on the user's videos, photographs, etc., and/or new invitations and acceptances (e.g., an invitation to the user to be followed by another user, an acceptance from another user to be followed by the user, etc.).

In an embodiment, social-business network server(s) 110 may also comprise a user interface module 113, which generates a profile-based user interface for each user to highlight the user's past activities. By viewing a user's profile, a potential employer may be able to put a genuine “face” on the user. Particularly, the potential employer can view a chronological representation over multiple years of all of the user's projects, pages, clubs, investments, educational experiences, friends, interests, and/or more through the user of videos. For example, the profile may identify the user and, optionally contact information for the user, and the college(s) or university(ies) and degree(s) earned or expected to be earned by the user, the user's work experience, photographs or other media related to the user (e.g., depicting the user in a variety of settings, including without limitation career positions, clubs, travel, projects, etc.), read and/or commented upon, employers contacted and positions for which the user interviewed, page popularity and/or activity (e.g., how many followers the user's account has and/or how many user accounts that user is following, etc.), and/or groups. In this manner, the user's experiences and interactions with the social network can be utilized to automatically generate a more complete and non-traditional résumé, which more accurately conveys the user's passions and character.

Additionally or alternatively, user interface module 113 may generate a user interface which comprises one or more recommendations or links to recommendations for the user. These recommendations may be from professors, coworkers, employers, friends, family, etc., and may take the form of a letter (e.g., an image of a scanned, signed letter), a webpage, a video, etc. For example, the recommendation may comprise a video of the recommender presenting the recommendation or otherwise discussing or conveying information about the user. In addition, the user interface may comprise additional information, such as one or more school transcripts or links to such transcripts (e.g., a link to a university site where the transcript may be viewed).

A user may establish relationships with other users (e.g., friends, companies, etc.) through user interface module 113. For example, a user may request to become a “friend” or otherwise be linked or associated with another user. If the other user accepts the requesting user's request, then both users are able to see the other user's profile (e.g., timeline, recommendations, etc.). Once a user has established relationships with other users, that user may subscribe to or otherwise receive news feeds concerning the related users' activities.

Users can have followers and follow other users. In other words, each user can be associated with a list of individuals who are connected with that user, as well as a list of individuals with whom that user is connected. For example, the user may select a friend or other linked user to follow, and be informed when the friend interviews with a company, or engages in some other activity (e.g., “Your friend John just interviewed with the CEO of First Solar Company, and added new photographs to his internship album.”). Similarly, the user's friends or other followers, including non-employer and/or employer users, can follow the user, and be informed of the user's activities through the site.

In an embodiment, users can be provided with a news feed comprising updates from the users that they are following. These updates may include, for example, new media (e.g., videos, images), new interactions with an employer user, new job opportunities, new comments, new “likes,” etc. Users may also be provided with updates about new followers, followings, job offers and/or invitations, messages, etc.

In an embodiment, a user can personalize his or her news feed. For instance, the user can choose which users he or she follows. Advantageously, both non-employer and employer users can be followed. When a user follows an employer user, the user may receive notifications, as well as updates, in the user's news feed when the employer user posts new job opportunities or posts updates. Thus, when an employer user posts a new job opportunity, it not only channels into a job opportunities group page (e.g., via job module 115), but it also channels into the news feeds of non-employer users who are following that particular employer user.

In an embodiment, social-business network server(s) 110 may also comprise a portfolio builder module 114. Portfolio builder module 114 collects and/or receives user data and generates a résumé or other portfolio based on the user data. Because the user data may comprise a complete social and professional history of the user, through posts, group memberships, media, chronology, and other interactions with the social networking aspects of social-business network server(s) 110, portfolio builder module 114 may build a portfolio capable of taking a viewer through every noteworthy attribute and aspect of the user's life. Although this portfolio may comprise standard formatting, it will generally be different and unique for each user. Furthermore, in an embodiment, the portfolio is dynamically generated when needed, and thus may be different for a single user depending on the time at which it is generated and/or viewed.

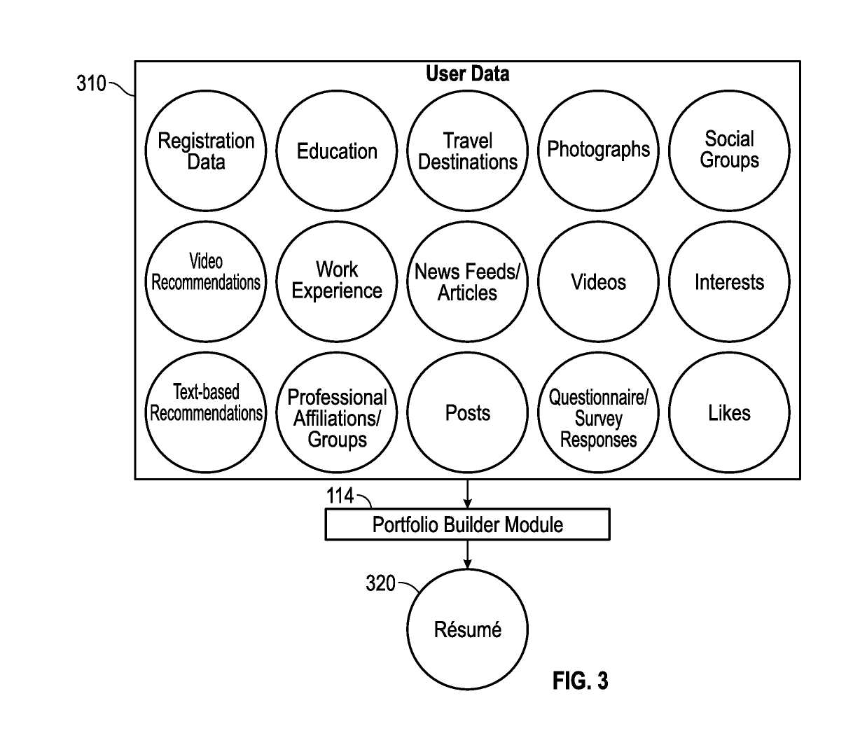

FIG. 3 illustrates an example portfolio builder module, according to an embodiment. The portfolio builder module 114 receives a variety of types of user data 310. User data or profile 310 may comprise both professional and social information generated through user interactions with server(s) 110. By way of illustration and not limitation, user data 310 may comprise one or more of registration data, video recommendations, text-based recommendations, educational history, work experience, professional affiliations and/or groups, travel destinations, news feeds and/or articles that a user subscribes to or has read, posts by or about the user, photographs, videos, questionnaire and/or survey responses, social group in which a user is involved, interests of a user, “likes” (e.g., media towards which a user has expressed a favorable indication), and the like. It should be understood that additional types of user data 310 may also be included.

After receiving user data 310, portfolio builder module 114 utilizes one or more of user data 310 to generate a résumé 320. As discussed in more detail elsewhere herein, résumé 320 may be an interactive résumé, with which a potential employer can interact. For example, résumé 320 may comprise an interactive timeline of the user's life, and the potential employer may be able to expand and compress various portions of the timeline to view those portions in greater or less detail. In addition, résumé 320 may be media-driven, in that it may comprise a variety of different types of interactive and/or non-interactive media, including photographs, videos, and the like, as well as text.

In an embodiment, non-employer users can upload a wide array or variety of videos, images, or other media. These media can show the user in a variety of settings, demonstrate a variety of skill sets, the user's diversity, and the like. For example, and by way of illustration only, a user may upload a video showing the user playing musical instrument(s), performing dance, performing outdoor sport(s) (e.g., snowboarding, biking, hiking, waterskiing, etc.), making college class presentation(s), presenting project(s), showcasing artwork, creative films, awards, etc., in front of a green screen, optionally with past employers, relatives, friends, etc. as references, performing task(s) at old job(s), being comedic, etc. Such videos not only express an individual's personality and character (e.g., to an employer), but also showcase his or her skill sets, capabilities, and can spark or otherwise indicate common interests between the individual and potential employers. Users may or may not be limited in the amount of media (e.g., video, images, etc.) uploads he or she is allowed. In an embodiment, the videos and video tags may be searchable by employer users via keyword entry in an employee search module 117 so as to identify potential employees with unique attributes which are not necessarily directly job related, such as sports played, musical instruments played, artistic abilities or interests, travel experience, and the like, as described in more detail below.

In an embodiment, the user may also be given the option to restrict who may view some or all of his or her media. For instance, and by way of illustration only, the user may allow both non-employer and employer users to view his or her media, or restrict viewing of the media or subsets of the media to only employer users, only non-employer users, or subsets of employer users and non-employer users (e.g., friends, family, potential employers in which the user is interested or to which the user has applied, etc.).

It should be understood that résumé 320 may also be or comprise a conventional text-based résumé (e.g., in Portable Document Format (PDF), Microsoft Word™ format, etc.). For instance, in addition to or instead of videos, images, and other media, in an embodiment, a non-employer user may also upload such a text-based résumé to their profile for employer users to view.

In an embodiment, a user can interact with portfolio builder module 114 (e.g., through user interface module 113) to generate a video presentation, including an interactive video presentation. This may be an option provided to a user, and may be recommended to users associated with a significant amount of accumulated user data (e.g., user profile, social media, etc.). Portfolio builder module 114 and/or user interface module 113 may provide the user with a wizard comprising one or more user-friendly screens for generating the interactive video presentation. For example, the wizard may instruct the user to record himself or herself in front of a green screen and upload the recorded video to the system (e.g., via user interface module 113). Portfolio builder module 114 may process the recorded video to replace green in the video with predetermined or selected elements, such as backgrounds, colors (e.g., white, gray, black), color schemes, and the like. In an embodiment, the user may choose to add one or more elements, such as photographs, videos, text, audio (e.g., music, voice-over, etc.), and the like. The user may manipulate the positioning, layout, and timing of these elements within the video presentation. The interactive video presentation may include images, video, and/or audio of, not only the user, but others as well. For instance, the video presentation may include a video recommendation from a previous employer, family member, friend, teacher, coach, supervisor, Eagle Scout leader, etc.

Advantageously, the interactive video presentation can focus on the personality of the user who is the subject of the presentation, much more so than the standard text-based one-page résumé. Employer users can visit and interact with a non-employer user's portfolio or profile in order to get to know the potential candidate on a personal level. This can eliminate the blind side of an interview, since the potential employer may already be informed of the personality and character of an individual before meeting the individual for the first time in an interview.

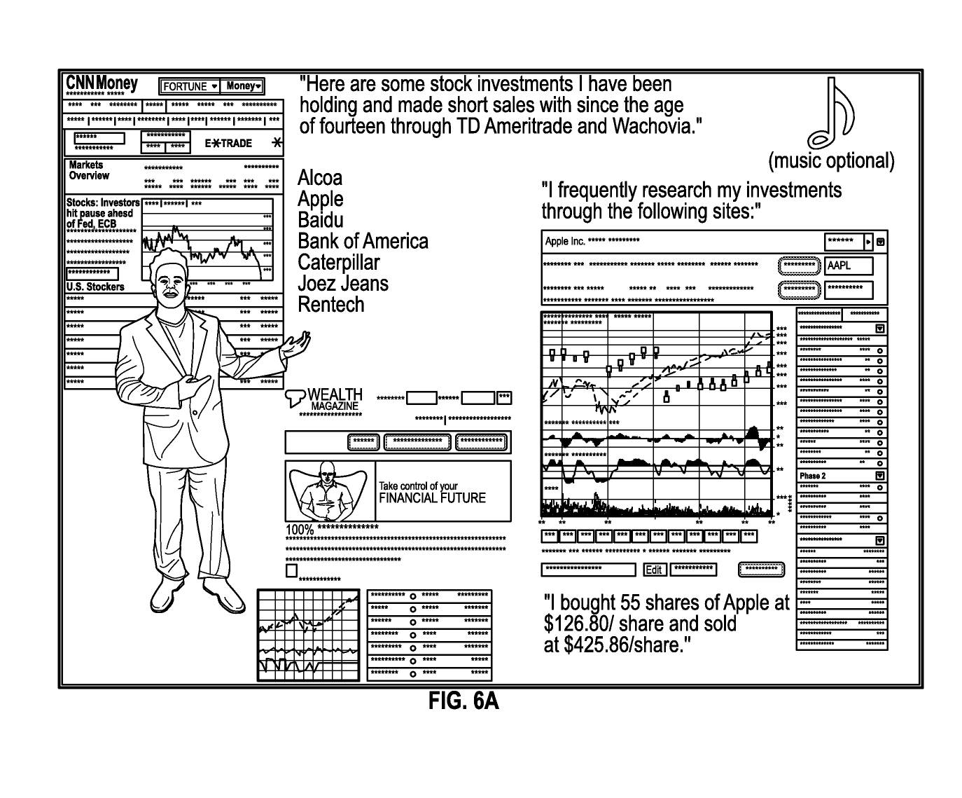

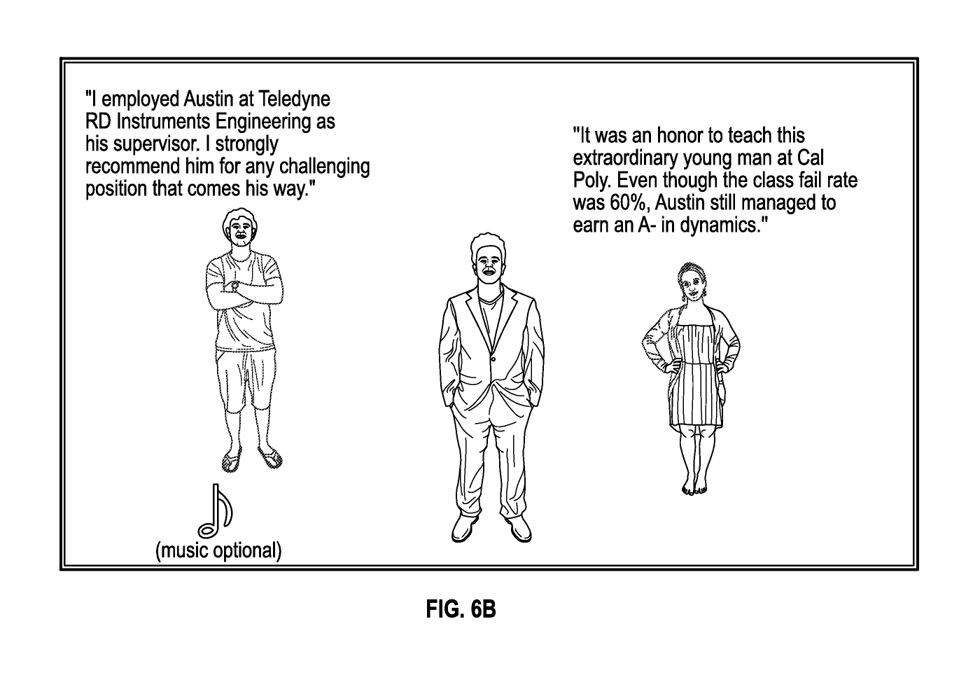

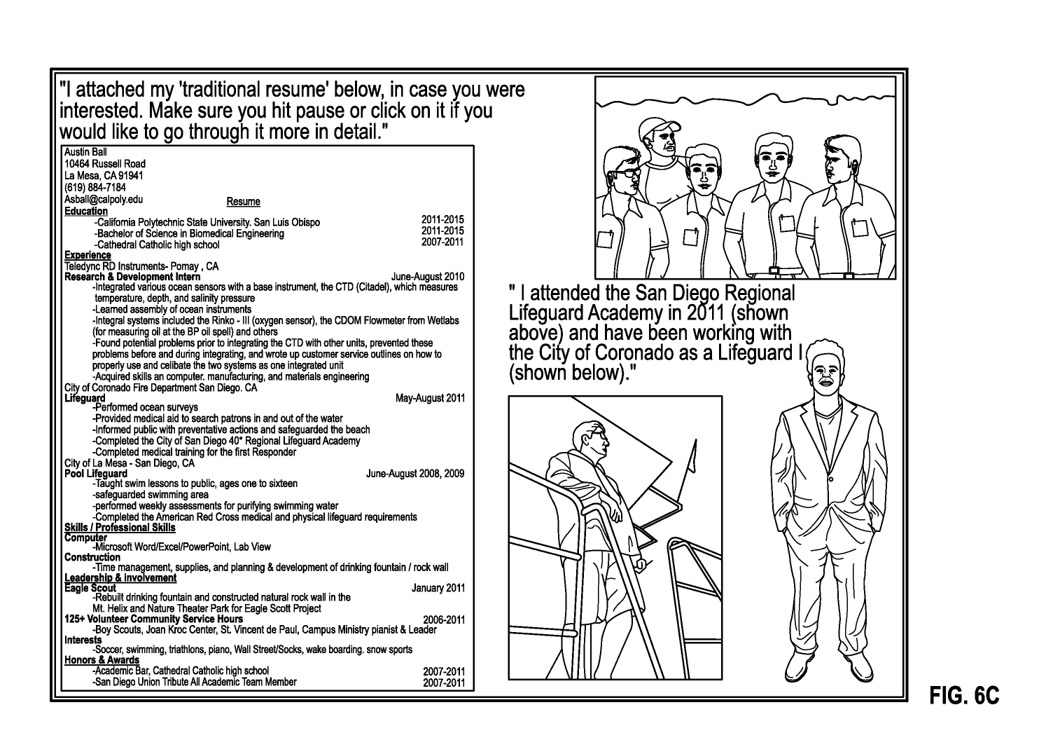

FIGS. 6A-6C illustrate an example interactive video presentation which may be generated by the portfolio builder module 114, according to an embodiment. The illustrated images are only some non-limiting examples of video uploads. Other examples of video uploads may relate to, without limitation, sports, hobbies, friends, school projects, references, slideshows, travel, an old work experience, miscellaneous subjects, etc., and may include other green-screen presentations. The illustrated quotations are examples of audio that would be verbally presented to a viewer of the video presentation, and is not necessarily visible within the presentation. The wizard or other user interface may also provide a user with tips or other assistance to make a more successful video presentation. By way of illustration and not limitation, such tips may advise the user as follows:
(1) Avoid wearing green or color schemes similar to green when recording in front of a green screen;
(2) Record yourself in a brightly lit area to minimize shadows and increase contrast with a green screen;
(3) If you choose a white color scheme for your background, avoid wearing white;
(4) If you choose a gray color scheme for your background, avoid wearing gray;
(5) If you choose a black color scheme for your background, avoid wearing black;
(6) Speak loudly and clearly when recording. It may be advantageous to use a sound stick;
(7) Use a tripod in order to stabilize the video recorder;
(8) Act professionally and tailor your appearance towards the career position you are seeking;
(9) Maintain eye contact; and
(10) It is usually a safe bet to “over dress” (e.g., wear a suit).

In an embodiment, social-business network server(s) 110 may also comprise a job module 115, which an employer/company may use to find potential employees and/or which a non-employer may use to find a potential employer. For example, job module 115 may comprise an employee search module which allows an employer/company to construct a query using one or more search criteria. These search criteria may include, without limitation, name, major, school, grade level, work experience and/or keywords. The job module 115 may also allow a prospective employer/company to search for individuals with unique attributes through the use of videos and video tags/categories. In other words, employers can search key words to find candidates who play soccer, play the piano, play golf, snow ski, who have traveled in other countries or regions, and so on, based on videos of such activities uploaded to the non-employer user profiles. Additionally or alternatively, job module 115 may comprise a job list module which allows an employer/company to post job opportunities. Posted job opportunities may be channeled into a group page. From the group page, users can apply for positions/job opportunities through the job list module. The posted job opportunities on the group page can be clickable, and available job postings can each comprise (and be segregated or searched by), without limitation, industry type, window of opportunity (e.g., expiration date of the posting), job description, requirements, and the like. It should be understood that job module 115 may comprise either the described employee search module, job list module, or a combination of the two. Thus, in an embodiment, an employer/company can use one or both methods to find potential employees.

The user interface for posting a new job opportunity may comprise inputs through which an employer user may specify information about the job, such as the number of applicants that can apply to the job or the number of openings for the job, an expiration date and/or time, job requirements, etc. Once a non-employer user has posted a job opportunity, the user will receive notifications whenever a new applicant is interested in the job. For each posted job opportunity, if an applicant applies to the job, the employer user can accept or decline the applicant's application, and/or comment on the applicant's interest. In an embodiment, employer users can review their lists of candidates and easily view the candidates' profiles. In this manner, an employer user may be able to filter and/or order or rate candidates according to their perceived suitability or desirability for the job.

According to an embodiment, non-employee users can apply to as many job postings as they wish. Non-employee users can also invite employer users to view their profiles or portfolios. The job module 115 can track these applications and/or invitations, and notify the non-employer user when he or she has been offered an interview and/or job position. For example, after an employer has accepted or denied an applicant user, that user may automatically receive a notification from the employer user with the employer user's response. For applicants which have been accepted for a job opportunity, the applicant user may be provided with a new, advanced communication button or other input (e.g., on a dashboard user interface available for authenticated non-employer users). The communication input allows the non-employer user to schedule and/or connect with the employer for a live interview (e.g., via a video chat application, such as Skype™, a phone call, etc.). Thus, accepted candidates can establish an interview appointment through the system's internal message system (e.g., user communication module 116).

In an embodiment, social-business network server(s) 110 comprise a user communication module 116, which provides communications between users of the system. The communications may comprise messaging including real-time messaging (e.g., instant messaging chat box). In an embodiment, the communications may also include video chat between a user and friend(s), family member(s), potential employer(s), etc. For example, the communication module 116 may support a real-time video interview between a job applicant and a potential employer. In an embodiment, this interview may be recorded and stored by server(s) 110 and capable of being transcribed (e.g., via standard speech-to-text conversion) or played back (e.g., by the interviewee and/or interviewer).

In an embodiment, social-business network server(s) 110 comprise a search module 117, which allows a user to search for other users. The user may search for other users based on one or more criteria, e.g., keyword, name, similarity score relative to the searching user, etc. For example, an employer may search for users who are seeking employment and have a significant similarity to a set of one or more qualities specified by the employer. The employer may then request to establish a relationship with the users identified in the search, and the identified users may either accept or deny the request. In an embodiment, a user may disallow their profiles or other data or subsets of this data to be included in employers' and/or other users' searches.

In an embodiment, social-business network server(s) 110 comprise an employee satisfaction module 118. Employee satisfaction module 118 may receive feedback from employee users of the system regarding an employer. The employee users may be associated with the employer's profile, for example, by establishing a relationship or other association with the employer using methods described elsewhere herein. The feedback may comprise comments, numerical ratings, and the like. The feedback may be anonymous to encourage forthrightness. In an embodiment, a numerical rating (e.g., 1 to 100) can be calculated based on the feedback (e.g., by averaging numerical ratings). The employee satisfaction rating may be displayed on one or more user interfaces associated with the employer, such that it is viewable by potential job applicants. In an embodiment, the employee satisfaction bar may be enabled or disabled by the employer or an administrator/operator of the system.

In an embodiment, social-business network server(s) 110 comprise a feedback module 119, which allows users to comment on and/or “like” other users' media (e.g., videos, images, posts, etc.). Thus, each user can expand and showcase his or her social circle. In addition, each user can help other user(s) get hired. In some embodiments, feedback module 119 may allow users to delete comments about their media at any time.

In an embodiment, social-business network server(s) 110 allow employer and non-employer users to interact in a social networking sense. Employers can comment on and/or “like” videos or other media of users, as well as see other comments on and/or “likes” of videos, images, and/or other media. Accordingly, the employer user is able to see how a non-employer user interacts socially among others. In addition, non-employer users can see which employer users (e.g., companies) actively use the site and interact with other non-employer users. In this way, employers will be able to express which profile media are exceptional, which media result in individuals getting hired into job positions, and which do not.

In an embodiment, social-business network server(s) 110 may also comprise one or more additional modules (not shown). For example, a module may be provided that tracks which users are following other users' profiles. In an embodiment, this module may provide the collected tracking information to users of the system. For instance, the module may provide one or more user interfaces to each user of the system. These one or more user interfaces may comprise a list of users that the user is following and/or a list of users who are following the user.

In an embodiment, social-business network server(s) 110 may also be linked or otherwise connected to other social media websites (e.g., Facebook™, Youtube™, LinkedIn™ etc.) to pull existing data to easily fill content for a user's profile. For example, one or more modules may implement or otherwise utilize one or more application programming interfaces (APIs) to one or more other social media websites.

In an embodiment, social-business network server(s) 110 may also provide additional resources and/or links to resources, for example, for high school and college users. These additional resources may help such users find or identify their passions and fields of interest. For example, colleges, universities, and companies may post short clips and videos that promote their purpose and encourage users to pursue a particular path. In an embodiment, one or more screens of a user interface may provide a list of companies with videos for sparking a user's interests or passions and/or marketing the company to users. This list of companies may be searchable, filterable, and/or navigable based on categories of the companies' businesses and/or category of available job type (e.g., business: administration, brokerage, entrepreneurship, finance, etc.; engineering: aerospace, biomedical, civil, electrical, environmental, manufacturing, mechanical, structural, etc.; liberal arts: teaching: various levels of grade school, special needs, etc.; science: biological sciences, chemistry, scientists, etc.).

In an embodiment, one or more screens of a user interface may provide a list of colleges and universities with tutorials and initiation videos that show aspects of the institution's educational and social life, as well as examples of what graduates may be able to do with their degrees. Colleges and universities may also attempt to market themselves through this user interface, although, in some embodiments, the main objective may be to help prospective students decide what field of study to pursue. As with the company list, the list of colleges/universities may be searchable, filterable, and/or navigable based on category or other criteria.

While the disclosed embodiments have been primarily described with respect to job applicants and employers, the disclosed systems and methods are not limited to this context. For example, in an additional or alternative embodiment, the systems and methods disclosed herein can be applied in a similar manner to college/university applicants and colleges/universities. It should be understood that the modules described herein within the context of employment may be adjusted to apply to the college admissions context as well. For instance, the employee satisfaction bar may be modified to be a student satisfaction bar, which measures the satisfaction of enrolled students with a school. In such an embodiment, individuals seeking to enroll in a college or university (e.g., student or non-student seeking graduate school admission, high school student seeking undergraduate school admission, etc.) can develop a professional résumé through interactions with the social networking aspects of the system. In some instance, these individuals may not even realize that their interactions are being used to develop the résumé.

By way of illustration and not limitation, a student could register with the system at an early age (e.g., during junior high school or high school). While still young, the student may primarily utilize the social networking aspects of the system, without regard to the business networking aspects. Thus, the user may enjoy a fun and enriching experience through server(s) 110, establishing relationships and other connections, participating in community groups or other social groups, and developing a rich history of passions and interests embodied in various media (e.g., photographs, videos, articles, posts, etc.). As the student enters the college admissions process, all of this information collected by server(s) 110 can be used by the system to generate a unique, individualized résumé (or other overview of the student's experience) for a college admissions application. The student can use the system to market themselves to colleges and universities, which may also be registered with server(s) 110, and discover an area of study to pursue. College admissions officers generally have difficulty choosing worthy students from traditional college résumés, which are simply words and numbers on a page. The system can revolutionize the college application process by generating truly personalized and engaging résumés for student-users. For instance, these résumés may be interactive and/or media-driven. Such a résumé may comprise an interactive timeline with media or links to media, such as images and video. For example, the résumé may feature a video recommendation from one or more of the student's teachers. In this manner, an admissions officer will no longer just see words and numbers on a page, but rather, a genuine, unique individual in a variety of settings and contexts (e.g., professional, educational, social, etc.). Similarly, once the student begins seeking employment (e.g., as the student nears graduation from college), the system can again generate a résumé. The résumé generation process in the employment context may be the same or different than the process used in the college admissions context. In an embodiment, the student may be able to review the résumé prior to submission, and may be able to remove, prevent inclusion of, or otherwise exclude certain aspects of the student's timeline or other data from the résumé.

In an embodiment, the system may also comprise a client application that is installed and executed on one or more of user system(s) 130. For example, the client application may comprise a mobile application executing on a user's smart phone. Alternatively or additionally, the client application may comprise a standard web browser application. The client application may execute one or more of the modules described herein, instead of or in addition to server(s) 110, and may communicate with server(s) 110 using standard communication protocols. For instance, in an embodiment, an employer may send an invite to a user, and within seconds, the user may be notified on his or her mobile application, and instantly commence a live video interview with the employer.

In an embodiment, the system may generate revenue through advertising income. Specifically, the system may display advertisements on the various user interfaces provided by user interface module 113, and charge advertisers via well-known techniques (e.g., per view, per click, per conversion, etc.). Additionally or alternatively, the system may generate revenue by charging users for registration and/or other services. In an embodiment, only employers and/or colleges/universities are charged for registration, while other users (e.g., students, job applicants) are allowed to register for free.

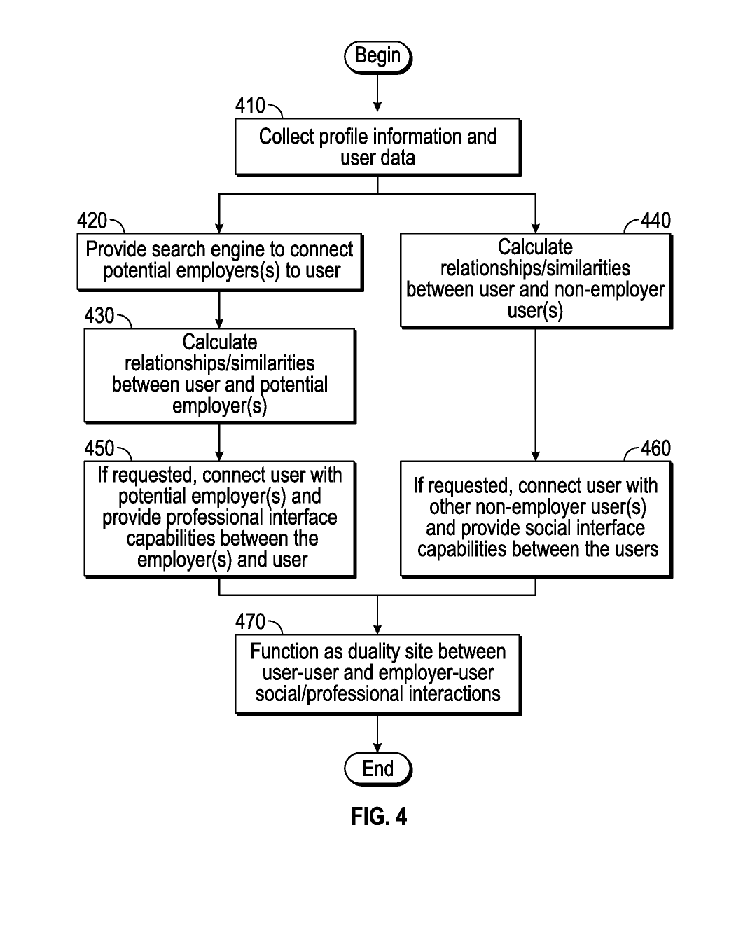

FIG. 4 illustrates a high-level process for the operation of a dual social networking and business networking site, according to an embodiment. The process begins in step 410 with the collection of profile information and/or user data. Such information and data may be collected at various stages, including prior to registration, during registration, and subsequent to registration. For instance, user data may be acquired from a plurality of interactions between a registered user and the system (e.g., media and text posts, establishment of relationships, participation in groups, etc.) and between the user and other users (e.g., communications with non-employer users and/or employers, participation in groups, etc.). User data may also be acquired from other users (e.g., posts concerning the user by another user).

Using this information and data collected, the system is able to search for users meeting specified criteria. In step 420, an employer can utilize a search engine provided by the system (e.g., search module 117) to identify users satisfying one or more criteria, including, without limitation, experience requirements, education requirements, geographical location, and non-business related skills and attributes such as sporting activities, clubs, travel, hobbies, etc. Such a search engine may also be provided to non-employer users, with identical, similar, or different available search criteria. For instance, in such an embodiment, a user could utilize the search engine to identify other users who are similar to the searching user based on a similarity search query (e.g., as determined by similarity determination module 115).

Based on the information and data collected about a user in step 410, the system is able to detect and/or calculate relationships and/or similarities between the user and other users. As discussed elsewhere herein, a similarity or rating can be calculated for any two or more users. Thus, in steps 430 and 440, a similarity may be determined between users. The algorithm for calculating a similarity may be the same regardless of whether one or more of the users are employers, or may be different if one or more of the users are employers.

In step 450, a user can be connected with a potential employer. For instance, the employer may identify a user as a potential job applicant utilizing the search engine in step 420. The employer may then send a request to the user. The user may either accept or deny the request. If the user accepts the request, a relationship or other link is established between the user and the employer. Once this relationship is established, a professional interface may be established between the user and the employer. For instance, the professional interface may comprise a user interface which permits the employer and user to schedule and/or conduct an interview (e.g., video chat), or otherwise exchange information. The employer may also be given access to the user's résumé, which may be dynamically generated based on the user's profile information and/or user data. For example, as discussed above, the résumé may be interactive and/or media-driven, providing the employer with a genuine overview of the user's life and character. It should be understood that the establishment of the relationship between an applicant and an employer may also be reversed. In other words, the applicant may conduct a search of potential employers using one or more criteria (e.g., a similarity), and then request a connection with the employer, which the employer may choose to accept or decline.

In step 460, the user can be connected with a non-employer user (e.g., friend, family member, acquaintance). For example, the user may send a request to the non-employer user. The non-employer user may either accept or deny the request. If the non-employer user accepts the request, a relationship or other link is established between the two users. Once this relationship is established, a social interface may be established between the user and the non-employer user. For instance, the social interface may comprise a user interface (e.g., a timeline) which permits the two users to share messages and media, to receive or view each other's social feeds/posts, to form groups, and the like.

Accordingly, in step 470, the system provides a duality site, which is capable of forming different types of relationships and providing different types of interfaces between two users based on the type of relationship. For example, one interface may be provided for a relationship between a user and non-employer user, and a different interface may be provided for a relationship between a user and an employer. It should be understood that the system is not limited to these two types of relationships and interfaces, and that different types of relationships and interfaces may be provided. For example, relationships may be established between a user and a school (e.g., college or university), and an admissions interface may be provided for such relationships. The admissions interface may provide a user interface which permits the users to exchange admissions-related information, such as an admissions application, a regular or interactive and/or media-driven résumé, admissions essays, recommendations, acceptance or rejection decisions, deadlines, and the like.

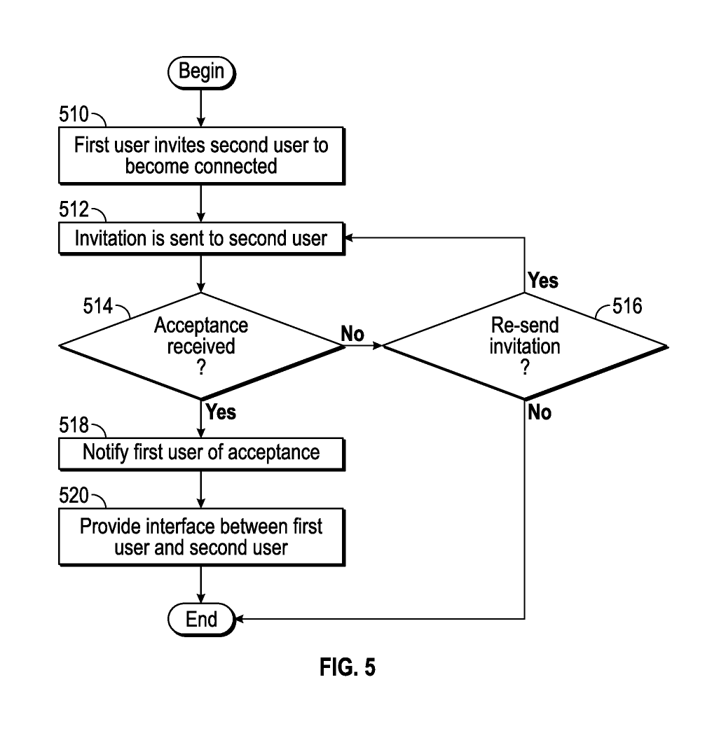

FIG. 5 illustrates a process for establishing a relationship between two users, according to an embodiment. In step 510, a first user identifies a second user with which the first user wishes to establish a connection. Either or both of the first user and the second user may be a non-employer, an employer, a college/university, or other entity. The first user may identify the second user by selecting or inputting a registered identification of the user. In an embodiment, the second user may not be a registered user of the system. In this case, the identification of the user may be an email address.

In step 512, an invitation is sent to the second user. The invitation may comprise an email message, a communication via an intra-system messaging system, a text message, or any other type of communication. The invitation may comprise a message, including a question such as “This user would like to follow you,” as well as instructions or an input (e.g., button or hyperlink) for accepting and/or declining the connection.

In step 514, the system determines whether an acceptance has been received. If a declination is received, the process may end. Otherwise, if an acceptance has not been received, the system may determine whether to re-send the invitation in step 512. In an embodiment, the user may specify a number of attempts to make. Alternatively or additionally, the number of attempts at establishing a connection may be a system setting. Alternatively, the system may only allow a single attempt, in which case, steps 514 and/or 516 may be omitted. If it is determined that the invitation should be re-sent (e.g., because the number of attempts has not been exhausted), the invitation is sent again in step 512. Once the invitation is re-sent, a counter for the number of attempts may be decremented or incremented, depending on whether the counter is counting down or counting up the number of attempts. In the case that the counter is counting down, no further invitations are attempted after the counter reaches zero. In the case that the counter is counting up, no further invitations are attempted after the counter reaches the specified number of attempts.

In step 514, if it is determined that an acceptance has been received, the first user is notified of the acceptance in step 518. Alternatively, this step may be omitted. Once the acceptance is received, the system provides an interface between the first and second users in step 520. In an embodiment, the type of interface provided may be different based on the type of relationship established (e.g., non-employer/non-employer, non-employer/employer, non-employer/university, etc.), as described elsewhere herein. For example, a social interface (e.g., media sharing, social feeds, messaging, etc.) may be provided between two non-employer users, while a professional interface (e.g., résumé viewing, messaging, interview scheduling and/or video chat, etc.) may be provided between a job-applicant user and employer user.

Educational Application

In addition to serving as a social and business networking tool, the disclosed systems and methods can also be utilized for educational purposes. In an embodiment, university professors, high school teachers, or other types of educators may be able to use the system as an enriching educational experience. For example, a professor (e.g., business professor) could require certain majors (e.g., business, finance, marketing, entrepreneurship majors) to register with social-business network server(s) 110 at the start of a class period. In some cases, a college or university may even automatically issue an account on server(s) 110 to each enrolled student, or require enrolled students to establish accounts on server(s) 110 upon enrollment. The system can then be used by the registered students in a similar manner as laboratory classes are used for engineering and science majors, i.e., to apply the topics discussed during lectures.

For example, business majors are often lectured on appropriate methods for making sales, maintaining a stage presence, projecting confidence, marketing themselves, making eye contact (e.g., during interviews), and/or tailoring their appearances in a manner suitable for a given context. However, with high college populations and short timeframes for absorbing particular materials, students seldom have time to apply the concepts taught in class to the real world. Typically and disadvantageously, students will only encounter and experience situations from their class lectures once they have already graduated college and/or applied for jobs, and before they have had a chance to learn fundamentals that can only be learned through experience. Such students may have textbook knowledge, but lack the experiential knowledge required to act professionally and appropriately around employers and clients.

The types of skills that students may learn through use of server(s) 110 may include, without limitation:
(1) Team skills: users can connect and interact with classmates, friends, and other acquaintances in a professional setting, discuss potential employers, and/or discuss how to improve one another's user profiles and/or other user data;
(2) Stage presence, confidence, eye contact: users can learn how appearance can affect an individual's chances at achieving a particular career position (e.g., 90% of employers have already made an employment decision in the first six seconds of an interview);
(3) Patience: users can see that it takes effort and hard work to receive a job offer, and that they must establish and maintain a professional demeanor throughout the application process, since there are almost always multiple applicants for any one job position;
(4) Awareness: users can learn that they must tailor their appearances to the particular career path that they wish to follow;
(5) Organizational skills, multi-tasking: users can learn how to properly execute professional presentations. Users may also be in contact with one or more employers at any given time, and will have to weigh the pros and cons offered from each career opportunity to choose the most appropriate, best-fit path.

As an additional example, professors could form group pages with their students in order to apply the fundamentals discussed in class to the real world or business world. Alternatively or additionally, students (or other users) can create group pages with a particular topic, objective, or function, and accumulate other users who have similar interest in the topic, objective, or function. These groups may be, but are not necessarily, employment related. Other topics, objectives, or functions of such group pages may include, without limitation:
(1) Projections about where the economy is headed. For example, some topics might include “Is the Restaurant Industry Growing or Declining?”, “Is the Pharmaceutical Industry Expanding?”, and “Are More Jobs Coming for Engineering Majors?”.
(2) Projections about up-and-coming countries in terms of employment. For example, some topics might include “Is China Looking for Bilingual Business Majors?” and “Has Brazil Been Hiring an Increasing Amount of American Engineers Recently?”.
(3) Ideas about going to graduate school. For example, a topic might be “Do Statistics Suggest that I Should Risk the Opportunity Cost of Student Loans and Complete Graduate School in the Hope that I Obtain a Better Career Salary?”.
(4) Ideas about internships. For example, a topic might be “Is It Acceptable to Complete the Full Two Years of My Internship Before I Move on to Find a Steadier Job?”.
(5) Ideas about studying abroad. For example, a topic might be “What Are the Advantages and Disadvantages of Completing a Study Abroad?”.

Example User Interfaces

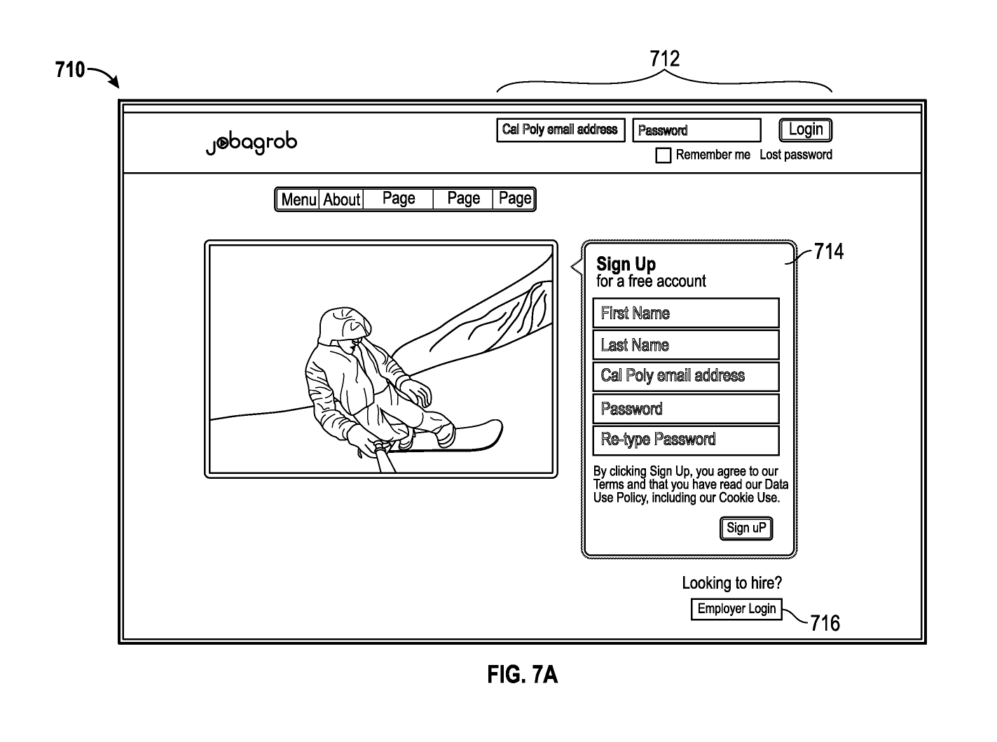

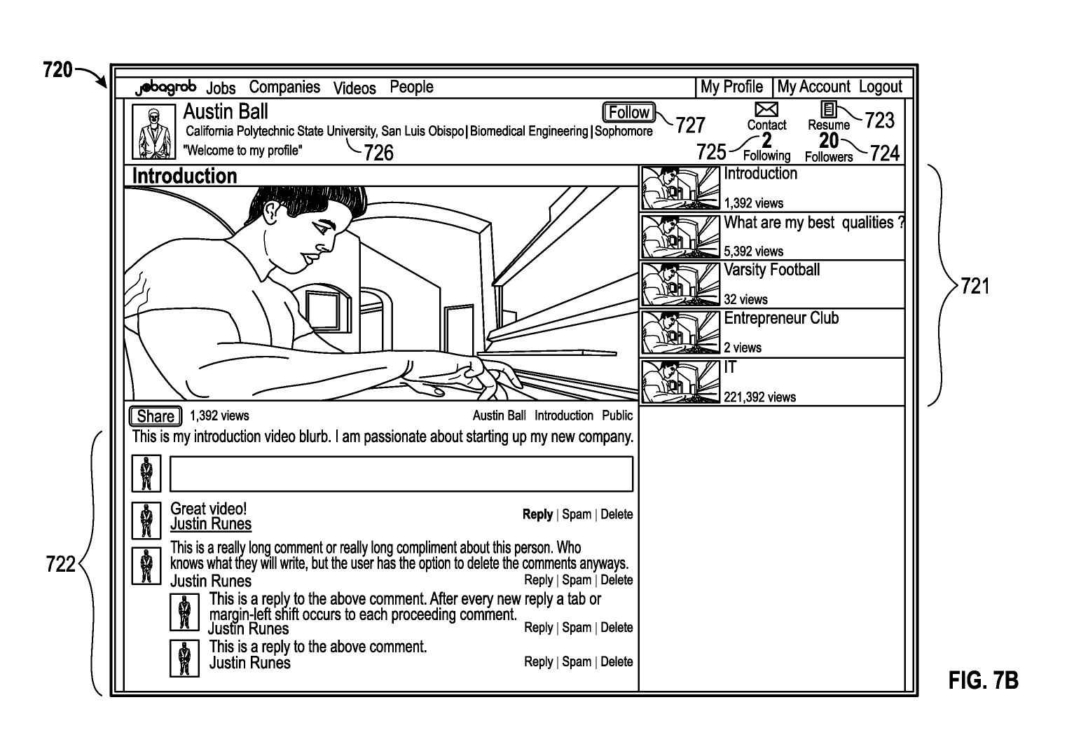

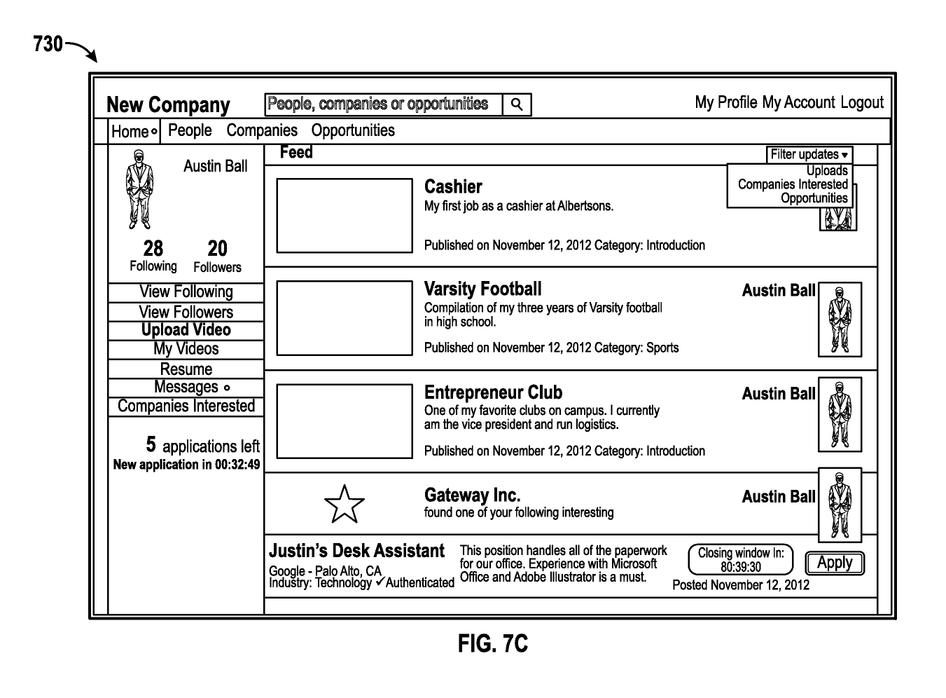

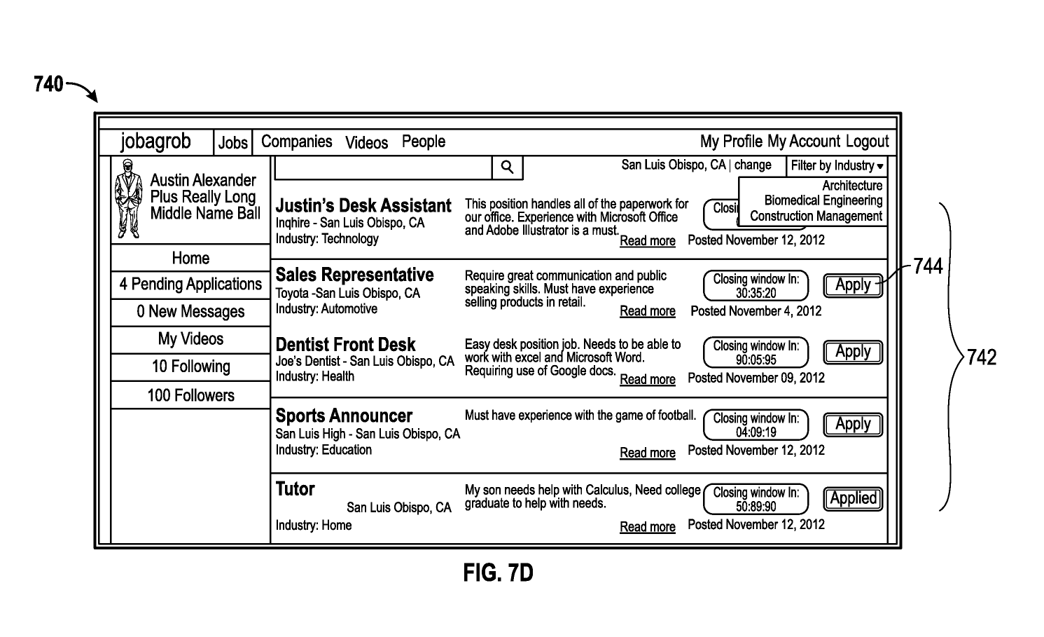

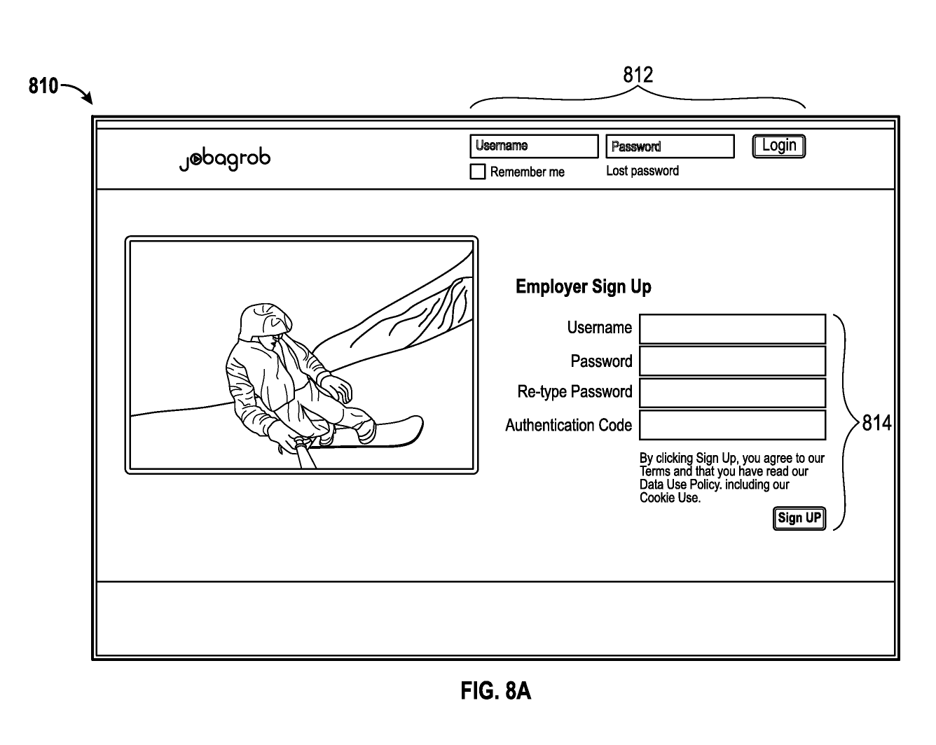

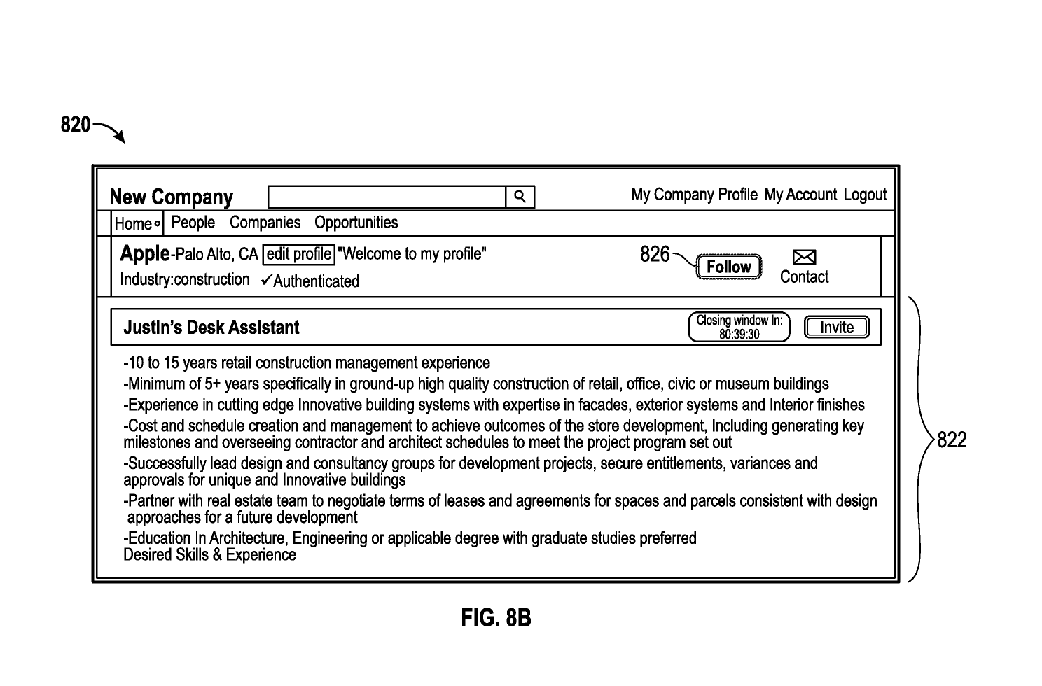

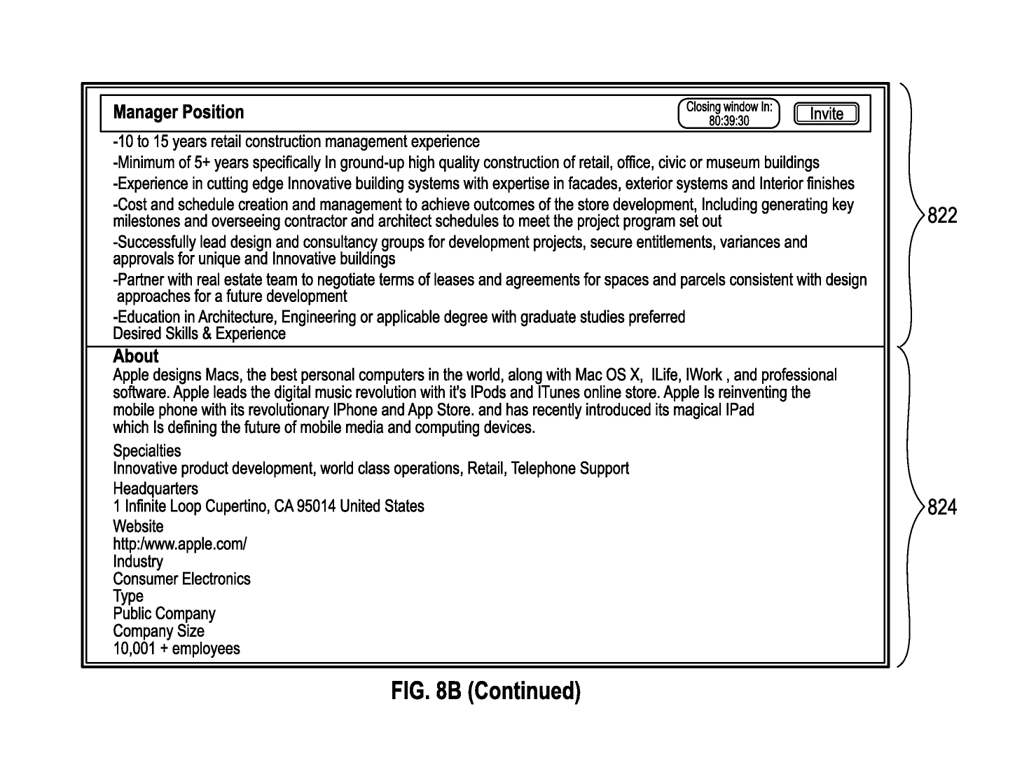

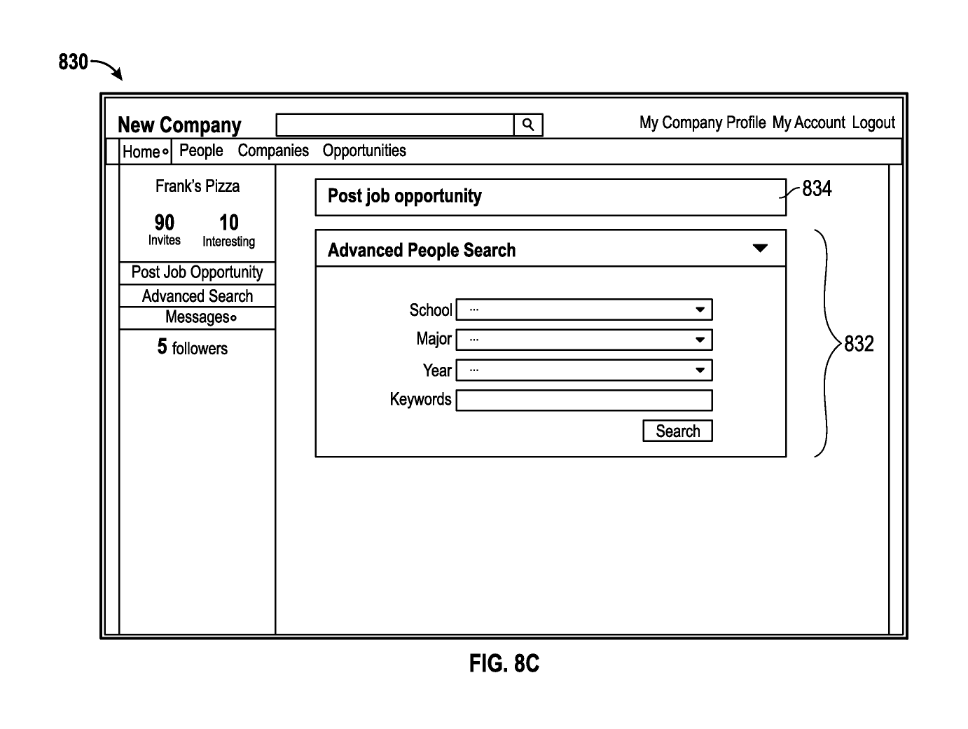

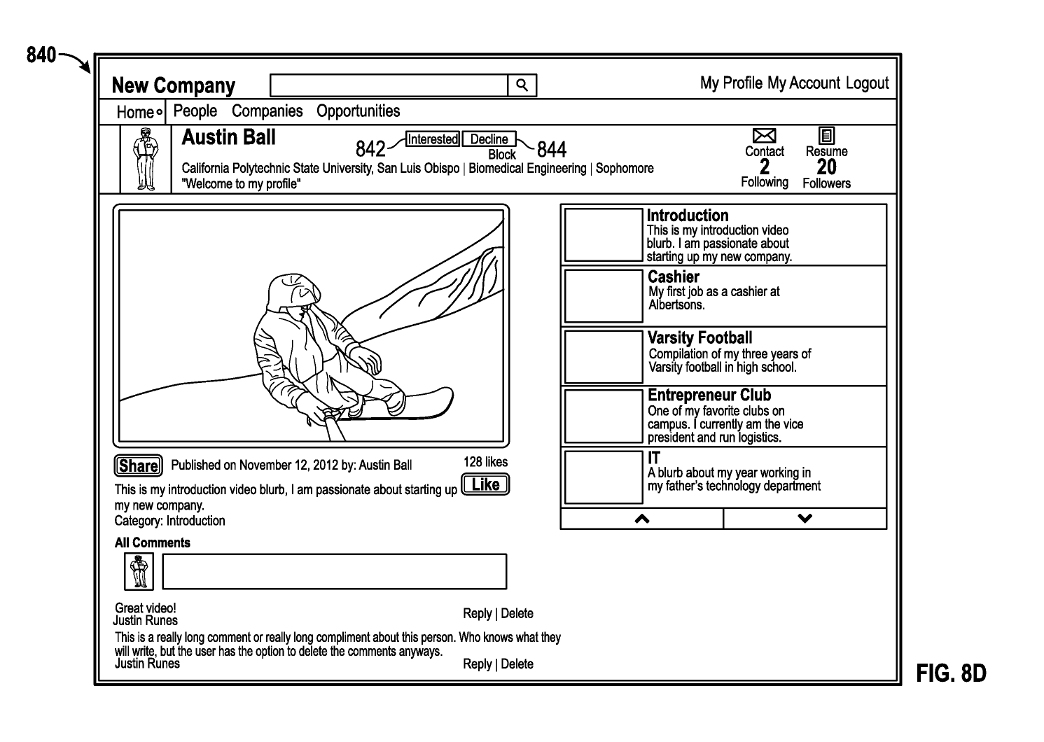

FIGS. 7A-7D illustrate example user interfaces which may be provided (e.g., by user interface module 113) to non-employer users, according to an embodiment. FIG. 7A illustrates an example 710 of a non-employer sign-in user interface. In an embodiment, the illustrated sign-in user interface may also be the primary home page for the non-employer portion of the site. Sign-in user interface 710 allows users to log in to (i.e., authenticate with) the system (e.g., using a username/email and password) using inputs 712 and/or create an account (e.g., via registration module 111) using inputs 714. The non-employer sign-in user interface may also provide an input 716 (e.g., hyperlink) for accessing the employer side of the site, such as employer sign-in user interface 810 (FIG. 8A).

FIG. 7B illustrates an example 720 of a non-employer profile page, according to one embodiment. Each user can post videos, images, and/or other media to his or her profile, as demonstrated by media list 721, and otherwise showcase himself or herself to other users, including both employer and non-employer users. These media can be commented on and/or “liked” by the other users, as demonstrated by comment section 722. A user can also upload a résumé to his or her account, and an input 723 (e.g., hyperlinked icon) for accessing the uploaded résumé can be provided on the user's profile page. Each profile can also display the number (724) and/or identities of users who are following the user and the number (725) and/or identities of users whom the user is following. In addition, information 726 about the user can be displayed on the user's profile page (e.g., at the top), including the user's school(s), major(s), year in school, status, etc. An input 727 can also be provided which allows a visiting user to follow the user represented by the visited profile page.

FIG. 7C illustrates an example 730 of a non-employer user's personal homepage following log-in to (i.e., authentication with) the site. The user's personal homepage 730 is the home base for the user, from which he or she can perform many or all of the functions provided by the site and/or navigate to many or all portions of the site. For instance, from homepage 730, the user can navigate through his or her personalized news feed, navigate to his or her profile, search for friends and companies, search and apply for job opportunities (e.g., by clicking on a job opportunities group page), log out, edit account settings, etc.

FIG. 7D illustrates an example 740 of a non-employer user's view of a job opportunities page. Job opportunities page 740 can be constantly updated with new job opportunities. The page may comprise a list of job opportunities which may be filtered or narrowed by user-specified or user-selected search criteria. For example, the user may specify a filter which limits the list of available job opportunities to a particular geographic region (e.g., city, Zip code, county, state, etc.), industry, set of qualifications, requirements, and the like. From job opportunities page 740, the user can apply for one or more job opportunities, for example, by clicking on an “apply” input 744 (e.g., hyperlinked icon). Each job opportunity listed may comprise information, such as the job title, employer, location, industry, brief description, posting date, expiration date and/or time and/or closing window (i.e., time remaining until expiration), and an input 744 for applying to the job opportunity. If the user clicks on the job opportunity or some input (e.g., hyperlink) associated with the job opportunity, he or she may be directed to a user interface with additional details or information, an application form, etc. If the user clicks on “apply” input 744, the user may be directed to a user interface which prompts the user to fill out requested information for the position. Once completed, the employer user which posted the job opportunity to which the user applied may be invited to view the user's profile and application. Both non-employer and employer users may have access to the job opportunities page 740, although their views of the page may differ.

FIGS. 8A-8D illustrate example user interfaces which may be provided (e.g., by user interface module 113) to employer users, according to an embodiment. FIG. 8A illustrates an example 810 of an employer sign-in user interface. In an embodiment, the illustrated sign-in user interface may also be the primary home page for the employer portion of the site. From the sign-in user interface 810, an employer user is able to log in to their account (i.e., authenticate with the system) using inputs 812 and/or create an account (e.g., via registration module 111) using inputs 814.

FIG. 8B illustrates an example 820 of an employer profile page, according to an embodiment. As illustrated, employer profile page 820 may comprise a filterable/searchable list 822 of job opportunities with accompanying descriptions. Users are able to navigate to the employer profile page 820 and view information 824 about the employer, apply for one or more job opportunities with the employer, request to follow the employer using an input 826 (e.g., such that updates from the employer will begin appearing in the following users' news feeds), etc.

FIG. 8C illustrates an example 830 of an employer user's corporate homepage following log-in to (i.e., authentication with) the site. The employer user's homepage 830 is the home base for the user, from which the employer can perform many or all of the functions provided by the site and/or navigate to many or all portions of the site. For instance, from homepage 830, an employer user can actively search for potential candidates through a search engine using inputs 832. Specifically, an employer can enter one or more preferred schools in the School input, one or more majors in the Major input, a preferred year in the Year input, and any number of different keywords in the Keyword input. The search engine allows many different potential employee attributes to be searched based on the information collected and posted by non-employee users, including pictures and videos identifying various interests and skills of the non-employee user as well as education and business related information. For example, the keyword input can be used to find candidates who have certain unique attributes, through the use of videos and video tags/categories. This search ability may be used to identify candidates who play certain selected sports, who play selected musical instruments, who have selected travel experience, who have artistic talent, and so on. An employer can also post new job opportunities using input(s) 834. Employers are also able to post a new status or other update for their followers. These statuses and other updates will show up in their followers' personalized news feeds.

FIG. 8D illustrates an example 840 of a non-employer user's profile page, as seen by an employer, e.g., to whom the non-employer user has applied. An employer can view the non-employer user's videos, photos, and/or other media, résumé, list of followers, list of users whom the user is following, etc. in order to evaluate the personality and character of the candidate. Then, the employer can indicate its interest in contacting or hiring the non-employer user. For example, the employer can express interest (e.g., in scheduling an interview) using input 842 and decline the non-employer user's application using input 844.

Example Database

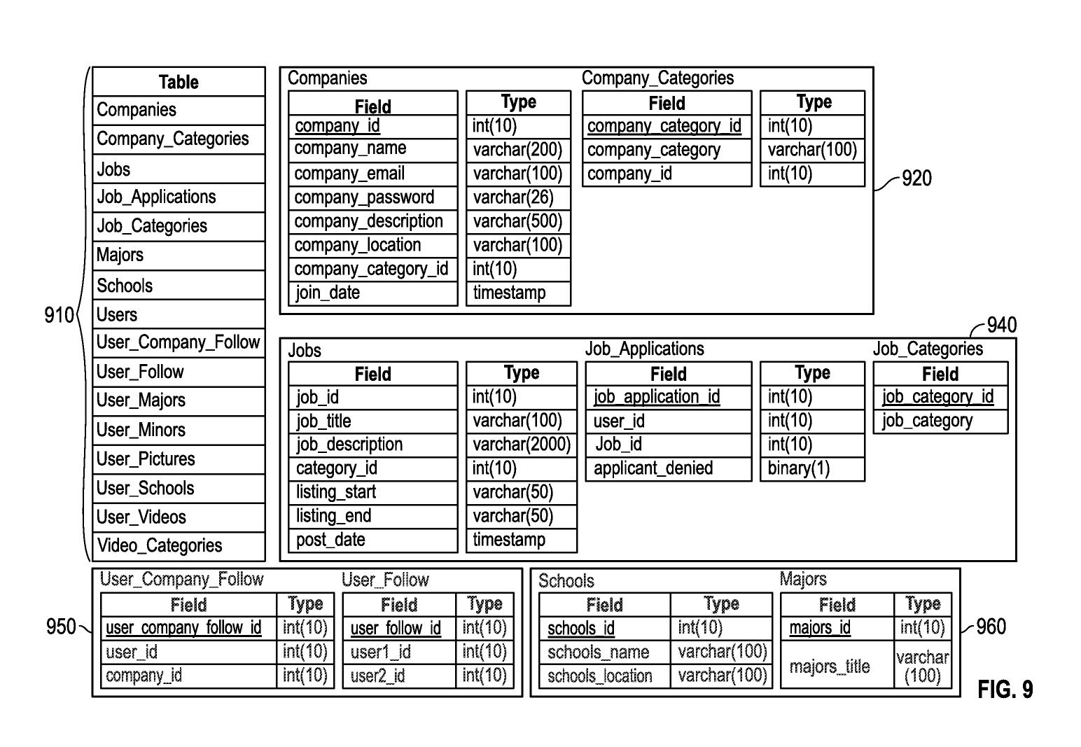

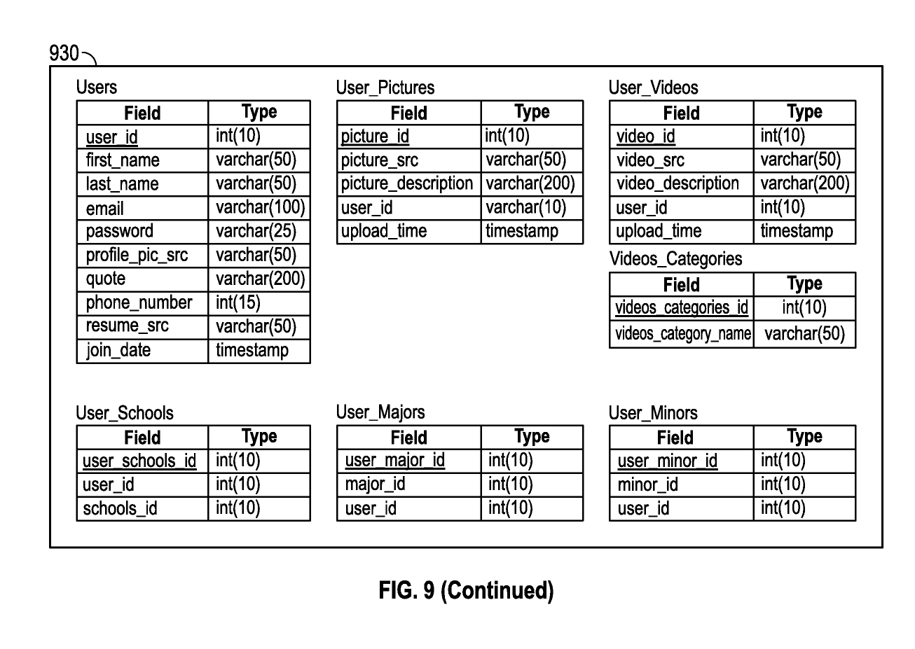

FIG. 9 illustrates some example database structures that may be utilized by the disclosed systems and methods, according to an embodiment. The example database structures represent a basic array of information that can be continually collected by the site as it acquires new users and as users interact with the site. Table 910 illustrates an example set of tables that may be used. The illustrated set includes Companies, Company_Categories, Jobs, Job_Applications, Job_Categories, Majors, Schools, Users, User_Company_Follow, User_Follow, User_Majors, User_Minors, User_Pictures, User_Schools, User_Videos, and Video_Categories tables.

Table set 920 illustrates two example tables that may be utilized to establish an employer user account. Specifically, the Companies table comprises fields for defining and describing an employer, including a unique company identifier (company_id). The Company_Categories table links a company to a company category using the company identifier (company_id) field.

Table set 930 illustrates several example tables that may be utilized to establish a non-employer user account. Specifically, the Users table comprises fields for defining and describing a non-employer user, including a unique user identifier (user_id). The User_Pictures table links a user to a picture using the user identifier. Similarly, the User_Videos table, User_Schools table, User_Majors table, and User_Minors tables link a user to a video, school, major, and minor, respectively. In addition, these tables may be linked to further tables using their own identifiers. For instance, the Video_Categories table defines a video category and can be linked to a video represented in the User_Videos table by linking a unique video identifier (video_id) from User_Videos with a unique video category identifier (video_category_id) from Video_Categories in a separate linking table (not shown).

Table set 940 illustrates example tables that may be utilized for job opportunities. Specifically, Jobs table comprises fields for defining and describing a job opportunity, including a unique job identifier (job_id). The Job_Applications table links a job opportunity with a non-employer user by linking the unique job identifier (job_id) with a unique user identifier (user_id). The Job_Applications table can also comprise a field which indicates whether or not the application has been denied (applicant_denied). In addition, the Job_Categories table defines a category description for a job and can be linked to an entry in the Jobs table through a separate linking table (not shown) which associates a job identifier (job_id) with a job category identifier (job_category_id).

Table set 950 illustrates example tables which can be used to implement the functionality of one user following another user. For example, the User_Company_Follow table associates a user identifier (user_id) from an entry in the Users table representing a non-employer user with a company identifier (company_id) from an entry in the Companies table representing an employer user. Similarly, the User_Follow table associates a user identifier (user1_id) from an entry in the Users table representing a non-employer user with another user identifier (user2_id) from an entry in the Users table representing another non-employer user.

Table set 960 illustrates additional tables which can be used to define schools and majors to be linked to non-employer users in the Users table. For example, the Schools table defines a particular school, including a unique school identifier (school_id), and can be linked to an entry for a non-employer user in the Users table through an entry in the User_Schools table which associates the user's user identifier (user_id) with the school identifier (school_id). Similarly, the Majors table defines a major, including a unique major identifier (major_id), and can be linked to an entry for a non-employer user in the Users table through an entry in the User_majors table which associates the user's user identifier (user_id) with the major identifier (major_id). It should be understood that users may be associated with a plurality of schools and/or majors using a plurality of entries in the User_Schools and/or User_Majors tables, respectively. It should also be understood that the illustrated tables merely represent an example embodiment, and that additional tables, fewer tables, and/or different tables may be used to achieve the same or similar associations and relationships.

Example System

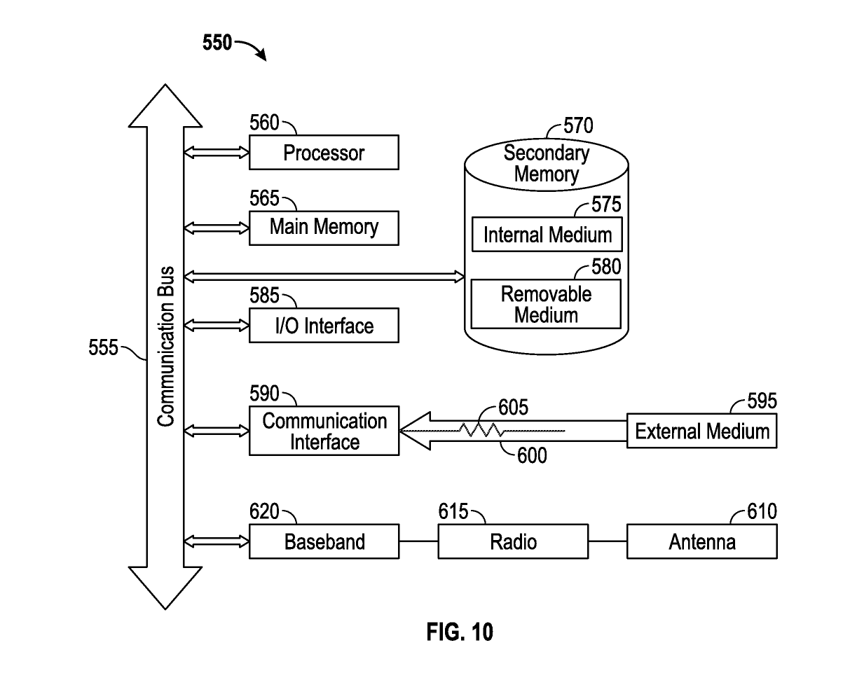

FIG. 10 is a block diagram illustrating an example wired or wireless system 550 that may be used in connection with various embodiments described herein. For example the system 550 may be used as or in conjunction with one or more of the mechanisms and processes previously described above. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560, such as one or more of the modules discussed above. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly limited by nothing other than the appended claims.

What is claimed is:

1. A system for providing social business-networking, the system comprising:
at least one hardware processor; and
at least one executable software module that, when executed by the at least one hardware processor,
establishes social relationships between a first user and a plurality of second users,
provides a social interface between the first user and each of the plurality of second users, wherein the social interface comprises a social user interface for social content sharing between the first user and the plurality of second users,
establishes a professional relationship between the first user and a third user, wherein the third user is associated with an employer,
automatically generates a résumé for the first user, and
provides a professional interface between the first user and the third user, wherein the professional interface provides a professional user interface to the third user, wherein the professional user interface comprises the résumé.

2. The system of claim 1, wherein the résumé comprises graphical media.

3. The system of claim 2, wherein the graphical media comprises one or more video recommendations.

4. The system of claim 1, wherein the at least one executable software module further collects user data from a plurality of interactions by the first user with the social user interface, and wherein the résumé is automatically generated based on the user data.

5. The system of claim 1, wherein the at least one executable software module determines a similarity rating between the first user and at least one other user, wherein the similarity rating is based on one or more criteria, and wherein the one or more criteria comprises a similarity between at least one attribute of the first user and at least one attribute of the at least one other user.

6. The system of claim 5, wherein the at least one other user is at least one of the plurality of second users, and wherein the social interface between the first user and the at least one of the plurality of second users comprises an indication of the similarity rating.

7. The system of claim 5, wherein the at least one other user is the third user, and wherein the professional interface comprises an indication of the similarity rating.

8. The system of claim 1, wherein the professional interface comprises a video communication between the first user and the third user.

9. The system of claim 1, wherein the at least one executable software module further receives feedback about the employer from a plurality of fourth users, wherein each of the fourth users are employees or former employees of the employer, and wherein the professional interface further provides an employee satisfaction rating to the first user, wherein the employee satisfaction rating is based on the feedback.

10. The system of claim 1, wherein the at least one executable software module further comprises a job module which
receives one or more search criteria from the third user;
identifies the first user based on the one or more search criteria;
provides the identification of the first user to the third user;
receives a request from the third user to establish the professional relationship;
invites the first user to establish the professional relationship with the third user;
receives an acceptance of the invitation from the first user; and
in response to receiving the acceptance, establishes the professional relationship between the first user and the third user.

11. The system of claim 10, wherein the job module includes an employee search module which provides a plurality of different search criteria for selective use by the third user in constructing a query, the search criteria comprising educational criteria, work experience criteria, and keywords relating to sporting, recreational, travel, hobbies, and other attributes of the first user.

12. The system of claim 1, wherein the at least one executable software module further provides an upload interface for the first user to upload videos.

13. A method for providing social business-networking, the method comprising, by at least one hardware processor:
establishing social relationships between a first user and a plurality of second users;
providing a social interface between the first user and each of the plurality of second users, wherein the social interface comprises a social user interface for social content sharing between the first user and the plurality of second users;
establishing a professional relationship between the first user and a third user, wherein the third user is associated with an employer;
automatically generating a résumé for the first user; and
providing a professional interface between the first user and the third user, wherein the professional interface provides a professional user interface to the third user, wherein the professional user interface comprises the résumé.

14. The method of claim 13, wherein the résumé comprises graphical media.

15. The method of claim 14, wherein the graphical media comprises one or more video recommendations.

16. The method of claim 13, further comprising collecting user data from a plurality of interactions by the first user with the social user interface, wherein the résumé is automatically generated based on the user data.

17. The method of claim 13, further comprising determining a similarity rating between the first user and at least one other user, wherein the similarity rating is based on one or more criteria, and wherein the one or more criteria comprises a similarity between at least one attribute of the first user and at least one attribute of the at least one other user.

18. The method of claim 17, wherein the at least one other user is at least one of the plurality of second users, and wherein the social interface between the first user and the at least one of the plurality of second users comprises an indication of the similarity rating.

19. The method of claim 17, wherein the at least one other user is the third user, and wherein the professional interface comprises an indication of the similarity rating.

20. The method of claim 13, wherein the professional interface comprises a video communication between the first user and the third user.

21. The method of claim 13, further comprising receiving feedback about the employer from a plurality of fourth users, wherein each of the fourth users are employees or former employees of the employer, and wherein the professional interface further provides an employee satisfaction rating to the first user, wherein the employee satisfaction rating is based on the feedback.

22. The method of claim 13, further comprising:
receiving one or more search criteria from the third user;
identifying the first user based on the one or more search criteria;
providing the identification of the first user to the third user;
receiving a request from the third user to establish the professional relationship;
inviting the first user to establish the professional relationship with the third user;
receiving an acceptance of the invitation from the first user; and
in response to receiving the acceptance, establishing the professional relationship between the first user and the third user.

23. A method for providing a combined social and business networking site, the method comprising, by at least one hardware processor:
storing non-employer profiles for a plurality of non-employer users of a combined social and business networking site;
storing employer profiles for a plurality of employers associated with employer users of the combined social and business networking site;
each non-employer profile comprising at least social data of social interest to other non-employer users and education and professional data of interest to potential employer users;
each employer profile comprising at least employer company information data, work category, job requirements and job openings;
providing a social interface between non-employer users for social content sharing between the non-employer users; and
providing a professional interface between a non-employer user and an employer user for sharing of business related data between the non-employer user and employer user, the business related data comprising at least a résumé of the non-employer user and at least job openings and job requirements of the employer with which the employer user is associated.

24. The method of claim 23, wherein the résumé of the non-employer user is generated from the non-employer user profile and data collected from interactions by the non-employer user with the social user interface.

25. The method of claim 23, wherein each non-employer profile includes non-employer user data and videos uploaded by the respective non-employer user, at least some of the videos illustrating selected non-employer user skills and attributes relevant to employer users.

26. The method of claim 25, further comprising receiving a search query from an employer user including a plurality of search criteria, the search criteria including at least searchable keywords associated with non-employer user attributes, and using keywords entered as a search query to search the stored non-employer profiles.

27. The method of claim 26, wherein the search criteria include education and work experience criteria.

28. The method of claim 26, further comprising searching videos and video tags in the stored non-employer profiles in response to entry of a search query including keywords relating to non-employer user attributes selected from the group consisting of at least sports played, musical instruments played, artistic abilities, and travel experience.

29. The method of claim 25, wherein each non-employer profile further comprises an employer user uploadable text based résumé of the non-employer user.
